(19) United States
(12) Patent Application Publication
(10) Pub. No.: US 2024/0351571 A1
(43) Pub. Date: Oct. 24, 2024

(54) VEHICLE SYSTEM, VEHICLE CONTROL METHOD, AND STORAGE MEDIUM

(71) Applicant: HONDA MOTOR CO., LTD., Tokyo (JP)

(72) Inventors: Ryoji Sakai, Wako-shi (JP); Asao Uenodai, Wako-shi (JP)

(21) Appl. No.: 18/761,371

(22) Filed: Jul. 2, 2024

Related U.S. Application Data
(63) Continuation of application No. 17/069,928, filed on Oct. 14, 2020.

(30) Foreign Application Priority Data
Oct. 31, 2019 (JP) 2019-198784

(51) Int. Cl. B60W 20/12; B60W 20/13

(52) U.S. Cl. CPC B60W 20/12; B60W 20/13

(57) ABSTRACT

A vehicle system which includes: an electric power control unit causes a power generation device to continue to generate electric power when the derived remaining amount of a fuel is smaller than a first threshold value or when a traveling distance calculated on the basis of the remaining amount of a fuel is smaller than a second threshold value and the output control unit calculates a second traveling distance that a vehicle is able to travel on the basis of the derived amount of charge or charge rate and causes an output unit to output information associated with the second traveling distance.

### CROSS-REFERENCE TO RELATED APPLICATIONS

This application is a Continuation of U.S. application Ser. No. 17/069,928 filed on Oct. 14, 2020, the entire contents of which is incorporated herein by reference.

Priority is claimed on Japanese Patent Application No. 2019-198784, filed Oct. 31, 2019, the content of which is incorporated herein by reference.

### BACKGROUND

### Field of the Invention

The present invention relates to a vehicle system, a vehicle control method, and a storage medium.

### Description of Related Art

In the related art, determining the power storage device shared power shared by a power storage device in consideration of the power efficiency in a power supply path from a power storage device to a load when the required power of the entire system is allocated from the power storage device shared power and the fuel cell shared power shared by a fuel cell and setting, as the fuel cell shared power, the power corresponding to a difference obtained by subtracting the power storage device shared power from the required power of the entire system is known (Japanese Unexamined Patent Application, First Publication No. 2017-162652)

### SUMMARY

However, in the related art, notifying an occupant of a distance which the vehicle can travel in consideration of the remaining amount of a fuel of a power generation device and the remaining amount of charge of a power storage device has not been fully taken into consideration.

The present invention was made in consideration of such circumstances, and an object of the present invention is to provide a vehicle system, a vehicle control method, and a storage medium which can notify an occupant of a distance which the vehicle can travel in consideration of the remaining amount of a fuel of a power generation device and the remaining amount of charge of a power storage device.

A vehicle system, a vehicle control method, and a storage medium according to the present invention have the following constitutions.

(1): A vehicle system according to an aspect of the present invention includes: a power generation device; a power storage device that stores electric power generated by the power generation device; and a power control device that controls power generation of the power generation device, derives the remaining amount of a fuel that can be supplied to the power generation device on the basis of the detection results of a first sensor attached to any one of the power generation device, a fuel storage unit, and a fuel supply path, derives an amount of charge or a charge rate of the power storage device on the basis of the detection results of a second sensor attached to the power storage device, calculates a first traveling distance that the vehicle is able to travel on the basis of the derived remaining amount of a fuel, and causes an output unit to output information associated with the first traveling distance, wherein, when the derived remaining amount of a fuel is smaller than a first threshold value or when the first traveling distance calculated on the basis of the remaining amount of a fuel is smaller than a second threshold value, the power control device causes the power generation device to continue to generate electric power, calculates a second traveling distance that the vehicle is able to travel on the basis of the derived amount of charge or charge rate, and causes an output unit to output information associated with the second traveling distance.

(2): In the aspect of (1), the power control device may continue to generate electric power with generated electric power having the maximum efficiency when the derived remaining amount of a fuel is smaller than the first threshold value or when a traveling distance calculated on the basis of the remaining amount of a fuel is smaller than the second threshold value.

(3): In the aspect of (1), the power control device may continue to generate electric power using the power generation device until there is no fuel that is able to supplied to the power generation device when the derived remaining amount of a fuel is smaller than the first threshold value or when a traveling distance calculated on the basis of the remaining amount of a fuel is smaller than the second threshold value.

(4): In the aspect of (1), the power control device may cause the output unit to output information indicating that information output from the output unit has been switched from information associated with the first traveling distance to information associated with the second traveling distance when the output unit is caused to output information associated with the second traveling distance.

(5): In the aspect of (1), the power control device may calculate, as the first traveling distance, a value obtained by subtracting a predetermined distance based on an error of the first sensor from an actual traveling distance based on the derived remaining amount of a fuel.

(6): A vehicle control method according to an aspect of the present invention that performs, by an in-vehicle computer that controls a vehicle system including a power generation device and a power storage device configured to store electric power generated by the power generation device, the vehicle control method comprising: deriving the remaining amount of a fuel supplied to the power generation device on the basis of the detection result of a first sensor attached to any one of the power generation device, a fuel storage unit, and a fuel supply path; deriving an amount of charge or a charge rate of the power storage device on the basis of the detection result of a second sensor attached to a power storage device configured to store electric power generated by the power generation device; calculating a first traveling distance that the vehicle is able to travel on the basis of the derived remaining amount of a fuel; causing an output unit to output information associated with the first traveling distance; and causing the power generation device to continue power generation and calculating a second traveling distance that the vehicle is able to travel on the basis of the derived amount of charge or charge rate, and causing an output unit to output information associated with the second traveling distance when the derived remaining amount of a fuel is smaller than a first threshold value or when the first traveling distance calculated on the basis of the remaining amount of a fuel is smaller than a second threshold value.

(7): A storage medium according to an aspect of the present invention storing a program causing an in-vehicle computer that controls a vehicle system including a power generation device and a power storage device configured to store electric power generated by the power generation device to execute: deriving the remaining amount of a fuel supplied to the power generation device on the basis of the detection result of a first sensor attached to any one of the power generation device, a fuel storage unit, and a fuel supply path; deriving an amount of charge or a charge rate of the power storage device on the basis of the detection result of a second sensor attached to a power storage device configured to store electric power generated by the power generation device; calculating a first traveling distance which the vehicle is able to travel on the basis of the derived remaining amount of a fuel; causing an output unit to output information associated with the first traveling distance; and causing the power generation device to continue power generation and calculating a second traveling distance which the vehicle is able to travel on the basis of the derived amount of charge or charge rate, and causing an output unit to output information associated with the second traveling distance when the derived remaining amount of a fuel is smaller than a first threshold value or when the first traveling distance calculated on the basis of the remaining amount of a fuel is smaller than a second threshold value.

According to the aspects of (1) to (7), it is possible to notify an occupant of a distance which the vehicle can travel in consideration of the remaining amount of a fuel of a power generation device and the remaining amount of electricity which is stored of a power storage device.

### BRIEF DESCRIPTION OF THE DRAWINGS

FIG. 1 is a diagram illustrating an example of a constitution of an electric vehicle according to an embodiment.

FIG. 2 is a diagram illustrating an example of a constitution of an FC system according to the embodiment.

FIG. 3 is a diagram illustrating an example of a constitution of a power control device.

FIG. 4 is a graph illustrating an example of an FC output.

FIG. 5 is a graph illustrating another example of the FC output.

FIG. 6 is a diagram illustrating an example of a change in traveling distance over time.

FIG. 7 is a flowchart for describing an example of a flow of processing performed using the power control device.

FIG. 8 is a flowchart for describing an example of the flow of processing performed using the power control device.

### DESCRIPTION OF EMBODIMENTS

Embodiment of a vehicle system, a vehicle control method, and a storage medium of the present invention will be described below with reference to the drawings. In the following description, it is assumed that an electric vehicle 10 is a fuel cell vehicle in which electric power generated by a power generation device is used as electric power for traveling.

### [Electric Vehicle]

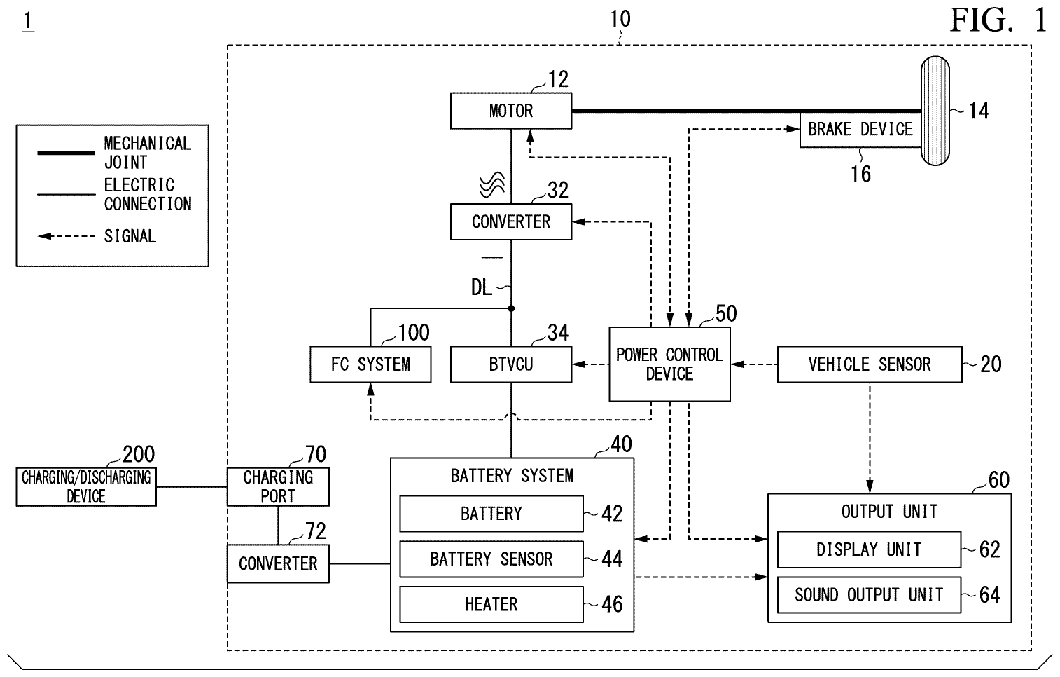

FIG. 1 is a diagram illustrating an example of a constitution of the electric vehicle 10 according to an embodiment. As shown in FIG. 1, the electric vehicle 10 includes, for example, a motor (a rotary electric machine) 12, drive wheels 14, a brake device 16, a vehicle sensor 20, a converter 32, a battery voltage control unit (BTVCU) 34, a battery system (a power storage device) 40, a power control device 50, an output unit 60, a charging port 70, a converter 72, and a fuel cell (FC) system 100. A combination of the power control device 50 and the FC system 100 is an example of the fuel cell system.

The motor 12 is, for example, a three-phase alternating current (AC) electric motor. A rotor of the motor 12 is joined to each of the drive wheels 14. The motor 12 outputs a driving force used for traveling of the electric vehicle 10 to the drive wheel 14 using at least one of electric power generated using the FC system 100 and electric power stored using the battery system 40. The motor 12 generates electricity using the kinetic energy of a vehicle when the vehicle is decelerating.

The brake device 16 includes, for example, a brake caliper, a cylinder which transmits hydraulic pressure to the brake caliper, and an electric motor which generates hydraulic pressure in the cylinder. The brake device 16 may include, as a backup, a mechanism which transmits hydraulic pressure generated through an operation of a brake pedal to the cylinder via a master cylinder. The brake device 16 is not limited to the constitution described above and may be an electronically controlled hydraulic pressure brake device which transmits hydraulic pressure of the master cylinder to the cylinder.

The vehicle sensor 20 includes an accelerator opening degree sensor, a vehicle speed sensor, and a brake stroke sensor. The accelerator opening degree sensor is attached to an accelerator pedal which is an example of an operation element configured to receive an acceleration instruction from a driver, detects an amount of operation of the accelerator pedal, and outputs the amount of operation to the power control device 50 as a degree of accelerator opening. The vehicle speed sensor includes, for example, a wheel speed sensor and a speed calculator attached to each wheel, integrates wheel speeds detected using the wheel speed sensor to derive a speed of a vehicle (a vehicle speed), and outputs the derived vehicle speed to the power control device 50 and the output unit 60. The brake stroke sensor is attached to the brake pedal, detects an amount of operation of the brake pedal, and outputs the detected amount of operation to the power control device 50 as an amount of brake stroke.

The converter 32 is, for example, an AC-direct current (DC) converter. A DC side terminal of the converter 32 is connected to a DC link DL. The battery system 40 is connected to the DC link DL via the BTVCU 34. The converter 32 converts an AC voltage generated using the motor 12 into a DC voltage and outputs the DC voltage to the DC link DL.

The BTVCU 34 is, for example, a step-up type DC-DC converter. The BTVCU 34 steps-up a DC voltage supplied from the battery system 40 and outputs the stepped-up DC voltage to the DC link DL. The BTVCU 34 outputs a regenerative voltage supplied from the motor 12 or an FC voltage supplied from the FC system 100 to the battery system 40.

The battery system 40 includes, for example, a battery 42, a battery sensor 44, and a heater 46.

The battery 42 is, for example, a secondary battery such as a lithium ion battery. The battery 42 stores, for example, electric power generated in the motor 12 or the FC system 100 and performs discharging for traveling of the electric vehicle 10.

The battery sensor 44 includes, for example, a current sensor, a voltage sensor, and the temperature sensor. The battery sensor 44 detects, for example, a current value, a voltage value, and a temperature of the battery 42. The battery sensor 44 outputs the detected current value, voltage value, temperature, and the like to the power control device 50. The temperature sensor of the battery sensor 44 is an example of a “second sensor attached to the power storage device.”

The heater 46 is provided at a position in which heat is transferred to the battery 42 and heats the battery 42 using electric power stored in the battery 42. The heater 46 heats the battery 42, for example, when the temperature of the battery 42 detected by the battery sensor 44 is lower than a predetermined temperature.

The FC system 100 is an example of the power generation device. Here, as described above, an example in which the electric vehicle 10 is a fuel cell vehicle and the power generation device is a fuel cell will be described. The FC system 100 is, for example, a fuel cell in which electricity is generated through a reaction of hydrogen contained in a fuel gas as a fuel with oxygen in air as an oxidant. The FC system 100 outputs the generated electric power to, for example, the DC link between the converter 32 and the BTVCU 34. Thus, electric power supplied from the FC system 100 is supplied to the motor 12 via the converter 32, is supplied to the battery system 40 via the BTVCU 34, or is stored in the battery 42.

The power control device 50 comprehensively controls a power relationship of the electric vehicle 10, which will be described in detail below.

The output unit 60 includes, for example, a display unit 62 and a sound output unit 64. The display unit 62 outputs information according to the control of the power control device 50 as an image. The sound output unit 64 outputs information according to the control of the power control device 50 through sound. For example, the display unit 62 displays an image indicating a distance which the vehicle can travel (or information associated with a distance which the vehicle can travel) of the electric vehicle 10 and the sound output unit 64 outputs sound indicating a distance which the vehicle can travel (or information associated with a distance which the vehicle can travel) of the electric vehicle 10. The display unit 62 may display an image indicating a vehicle speed or the like output using the vehicle sensor 20.

The charging port 70 is oriented toward outside of a vehicle body of the electric vehicle 10. The charging port 70 is connected to a charging/discharging device 200 via a charging cable 220. The charging cable 220 includes a first plug 222 and a second plug 224. The first plug 222 is connected to the charging/discharging device 200 and the second plug 224 is connected to the charging port 70. The electric power supplied from the charging/discharging device 200 is supplied to the charging port 70 via the charging cable 220.

The charging cable 220 includes a signal cable installed in a power cable. The signal cable mediates communication between the electric vehicle 10 and the charging/discharging device 200. Therefore, a power connector and a signal connector are provided in each of the first plug 222 and the second plug 224.

The converter 72 is provided between the charging port 70 and the battery system 40. The converter 72 converts a current introduced from the charging/discharging device 200 via the charging port 70, for example, an AC current into a DC current. The converter 72 outputs the converted DC current to the battery system 40.

### <FC System 100>

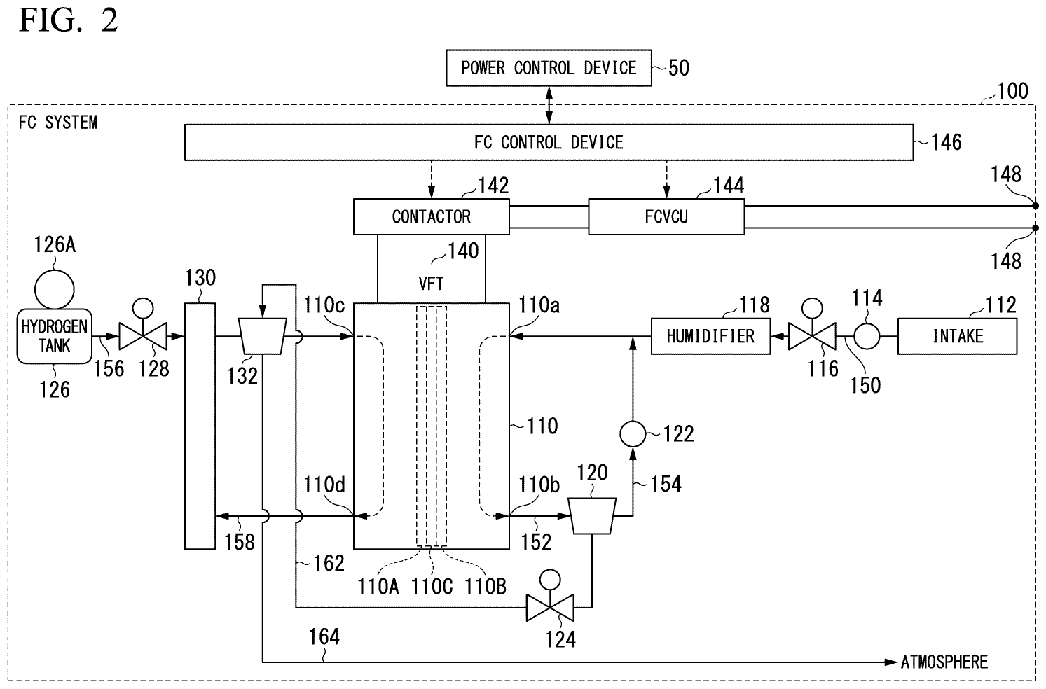

FIG. 2 is a diagram illustrating an example of a constitution of the FC system 100 according to the embodiment.

As shown in FIG. 2, the FC system 100 includes, for example, an FC stack 110, an intake 112, an air pump 114, a sealing inlet valve 116, a humidifier 118, a first gas-liquid separator 120, an exhaust gas recirculation pump 122, a drain valve 124, a hydrogen tank 126, a fuel sensor 126A, a hydrogen supply valve 128, a hydrogen circulation unit 130, a second gas-liquid separator 132, the temperature sensor 140, a contactor 142, a fuel cell voltage control unit (FCVCU) 144, and an FC control device 146.

The FC stack 110 includes a stacked body (not shown) in which a plurality of fuel cells are stacked and a pair of end plates (not shown) having this stacked body arranged therebetween on both sides in a stacking direction.

Each of the fuel cells includes a membrane electrode assembly (MEA) and a pair of separators having this membrane electrode assembly arranged therebetween on both sides in a joining direction.

The MEA includes an anode 110A which includes an anode catalyst and a gas diffusion layer, a cathode 110B which includes a cathode catalyst and a gas diffusion layer, and a solid-state polymer electrolyte membrane 110C which includes a cation exchange membrane arranged between the anode 110A and the cathode 110B on both sides in a thickness direction.

A fuel gas containing hydrogen as a fuel is supplied from the hydrogen tank 126 to the anode 110A and air which is an oxidant gas (a reaction gas) containing oxygen as an oxidant is supplied from the air pump 114 to the cathode 110B.

The hydrogen supplied to the anode 110A is ionized through a catalytic reaction on the anode catalyst and the hydrogen ions move to the cathode 110B via the appropriately humidified solid-state polymer electrolyte membrane 110C. The electrons generated along with the movement of the hydrogen ions can be taken outside to an external circuit (the FCVCU 144 or the like) as a DC current.

The hydrogen ions which have moved from the anode 110A onto the cathode catalyst of the cathode 110B react with oxygen supplied to the cathode 110B and the electrons on the cathode catalyst to generate water.

The air pump 114 includes a motor or the like which is driven and controlled using the FC control device 146, takes in air from the outside via the intake 112 using a driving force of this motor and compresses the taken in air, and sends the compressed air to a oxidant gas supply path 150 connected to the cathode 110B.

The sealing inlet valve 116 is provided in the oxidant gas supply path 150 configured to connect the air pump 114 to a cathode supply port 110a through which air can be supplied to the cathode 110B of the FC stack 110 and is opened and closed under the control of the FC control device 146.

The humidifier 118 humidifies air sent from the air pump 114 to the oxidant gas supply path 150. To be more specific, the humidifier 118 includes, for example, a water permeable membrane such as a hollow fiber membrane and adds moisture to air by bringing the air from the air pump 114 into contact with the air via the water permeable membrane.

The first gas-liquid separator 120 separates a cathode exhaust gas discharged into an oxidant gas discharge path 152 and liquid water without being consumed through the cathode 110B. The cathode exhaust gas separated from the liquid water through the first gas-liquid separator 120 flows into an exhaust gas recirculation path 154.

The exhaust gas recirculation pump 122 is provided in the exhaust gas recirculation path 154, mixes the cathode exhaust gas flowing from the first gas-liquid separator 120 into the exhaust gas recirculation path 154 with air flowing through the oxidant gas supply path 150 from the sealing inlet valve 116 toward the cathode supply port 110a, and supplies the mixture to the cathode 110B again.

The liquid water separated from the cathode exhaust gas using the first gas-liquid separator 120 is discharged to the second gas-liquid separator 132 provided in a fuel gas supply path 156 via a connection path 162. The liquid water discharged to the second gas-liquid separator 132 is discharged to the atmosphere via a drain pipe 164.

The hydrogen tank 126 stores hydrogen in a compressed state. The fuel sensor 126A is, for example, a sensor attached to the hydrogen tank 126 which is a fuel storage unit and detects the remaining amount of hydrogen stored in the hydrogen tank 126.

The fuel sensor 126A is not limited to this, and may be provided in the fuel gas supply path 156 which is a fuel supply path, and may detect information for deriving the remaining amount of the hydrogen tank 126 by detecting an amount of hydrogen supplied from the hydrogen tank 126 to an anode supply port 110c. A location in which the fuel sensor 126A is installed is not limited to the above location and may be any location of the FC system 100 which is a power generation device in which the remaining amount of a fuel can be detected. For example, the fuel sensor 126A may detect information for deriving the remaining amount of the hydrogen tank 126 by detecting a time over which the hydrogen supply valve 128 has been open, an angle at which the valve is open, and the like. The fuel sensor 126A is an example of a “first sensor attached to any one of the power generation device, the fuel storage unit, and the fuel supply path.”

The hydrogen supply valve 128 is provided in the fuel gas supply path 156 through which the hydrogen tank 126 is connected to the anode supply port 110c through which hydrogen can be supplied to the anode 110A of the FC stack 110. When opened under the control of the FC control device 146, the hydrogen supply valve 128 supplies the hydrogen stored in the hydrogen tank 126 to the fuel gas supply path 156.

The hydrogen circulation unit 130 circulates an anode exhaust gas discharged to a fuel gas discharge path 158 without being consumed using the anode 110A to the fuel gas supply path 156.

The second gas-liquid separator 132 separates an anode exhaust gas and liquid water which circulate from the fuel gas discharge path 158 to the fuel gas supply path 156 through an action of the hydrogen circulation unit 130. The second gas-liquid separator 132 supplies the anode exhaust gas separated from the liquid water to the anode supply port 110c of the FC stack 110.

The temperature sensor 140 detects temperatures of the anode 110A and the cathode 110B of the FC stack 110 and outputs a detection signal to the FC control device 146.

The contactor 142 is provided between the anode 110A and the cathode 110B of the FC stack 110 and the FCVCU 144. The contactor 142 electrically connects or disconnects between the FC stack 110 and the FCVCU 144 on the basis of the control from the FC control device 146.

The FCVCU 144 is, for example, a step-up type DC-DC converter. The FCVCU 144 is arranged between the anode 110A and the cathode 110B of the FC stack 110 via the contactor 142 and an electric load. The FCVCU 144 steps-up a voltage of an output terminal 148 connected to the electric load side to a target voltage determined using the FC control device 146. The FCVCU 144, for example, steps-up a voltage output from the FC stack 110 and outputs the stepped-up voltage to the output terminal 148.

The FC control device 146 is included in a part of an electric power control unit configured to control power generation of the power generation device. For example, the FC control device 146 controls power generation so that electric power is generated at the FC required power required for the FC system 100. The FC control device 146 controls power generation so that electric power is generated with a required amount of power generation.

When the power control device 50 determines that the FC system 100 needs to be warmed up and the FC required power required for the FC system 100 is greater than or equal to a predetermined power, the FC control device 146 performs warm-up control of the FC system 100. When the power control device 50 acquires, for example, a detection signal obtained using the temperature sensor 140 from the FC control device 146 and a temperature of the FC stack 110 detected using the temperature sensor 140 is less than a threshold value, the power control device 50 determines that the FC system 100 needs to be warmed up. When the power control device 50 acquires a detection signal obtained using the temperature sensor 140 from the FC control device 146 while performing warm-up control of the FC system 100 and a temperature of the FC stack 110 detected using the temperature sensor 140 is greater than or equal to a threshold value, the power control device 50 determines that the warm-up control of the FC system 100 is completed.

### <Power Control Device 50>

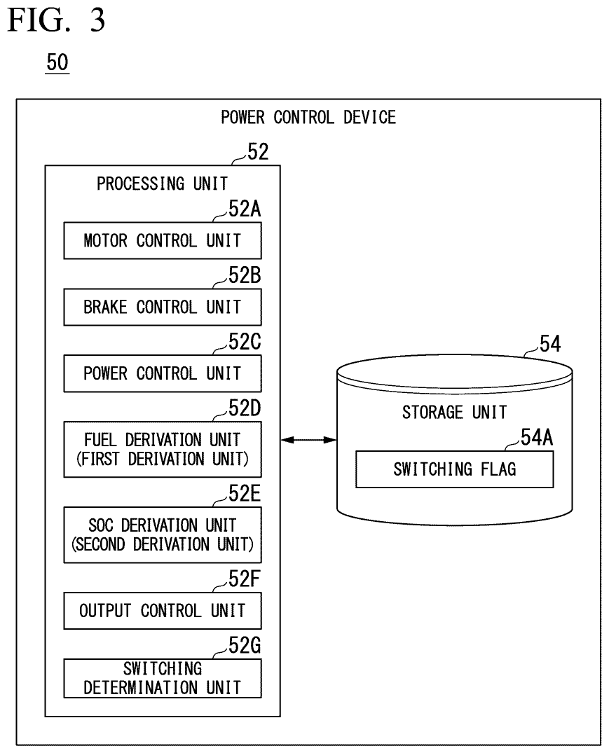

FIG. 3 is a diagram illustrating an example of a constitution of the power control device 50. The power control device 50 includes, for example, a processing unit 52 and a storage unit 54. The processing unit 52 includes, for example, a motor control unit 52A, a brake control unit 52B, an electric power control unit 52C, a fuel amount derivation unit (a first derivation unit) 52D, a state of charge (SOC) derivation unit (a second derivation unit) 52E, an output control unit 52F, and a switching determination unit 52G. The motor control unit 52A, the brake control unit 52B, the electric power control unit 52C, the fuel derivation unit 52D, the SOC derivation unit 52E, the output control unit 52F, and the switching determination unit 52G may be replaced with separate control devices, for example, control devices such as a motor ECU, a brake ECU, and a battery ECU.

The processing unit 52 is realized, for example, through a hardware processor such as a central processing unit (CPU) configured to execute a program (software). Some or all of these constituent elements may be implemented through hardware (a circuit section; including a circuitry) such as a large scale integration (LSI), an application specific integrated circuit (ASIC), a field-programmable gate array (FPGA), and a graphics processing unit (GPU) or may be realized in cooperation of software and hardware.

The program may be stored in advance in a storage device (a non-transitory storage medium) such as a hard disk drive (HDD) and a flash memory, be stored in a removable storage medium (non-transitory storage medium) such as a DVD or a CD-ROM, or may be installed by installing a storage medium in a drive device.

The motor control unit 52A calculates a driving force required for the motor 12 on the basis of the output of the vehicle sensor 20 and controls the motor 12 such that the calculated driving force is output.

The brake control unit 52B calculates a braking force required for the brake device 16 on the basis of the output of the vehicle sensor 20 and controls the brake device 16 such that the calculated braking force is output.

The electric power control unit 52C calculates a total required power required for the battery system 40 and the FC system 100 on the basis of the output of the vehicle sensor 20. For example, the electric power control unit 52C may calculate a torque which the motor 12 needs to output on the basis of a degree of accelerator opening and a vehicle speed and calculate a total required power by summing a drive shaft required power obtained from the torque and the rotational speed of the motor 12 and an electric power required by an auxiliary machine or the like.

The electric power control unit 52C calculates a charging/discharge required power of the battery 42 on the basis of the SOC of the battery 42 derived by the SOC derivation unit 52E. Furthermore, the electric power control unit 52C calculates the FC required power required for the FC system 100 by subtracting the charge/discharge required power of the battery 42 from the total required power (setting a discharge side to be positive) and causes the FC system 100 to generate electric power corresponding to the calculated FC required power.

The fuel derivation unit 52D derives the remaining amount of fuel able to be supplied to the FC system 100 (an example of the power generation device) on the basis of the detection result of the fuel sensor 126A. For example, the fuel derivation unit 52D may handle the detected remaining amount of hydrogen as it is as the remaining amount of a fuel. The fuel derivation unit 52D may derive a remaining amount in the hydrogen tank 126 on the basis of the detected amount of supplied hydrogen or the like.

The SOC derivation unit 52E derives the SOC of the battery 42 (hereinafter also referred to as a “battery charge rate”) on the basis of the output of the battery sensor 44. For example, the SOC derivation unit 52E calculates the SOC on the basis of an integrated value of the detected charge/discharge current. The SOC derivation unit 52E may estimate a deterioration rate and a full charge capacity of the battery 42 before deriving the SOC and derive the SOC on the basis of the estimation result. The SOC derivation unit 52E outputs the derived SOC to the switching determination unit 52G.

Although an example in which the SOC derivation unit 52E derives the SOC will be described below, the present invention is not limited thereto. For example, the SOC derivation unit 52E may derive an amount of charge of the battery 42 on the basis of the output of the battery sensor 44 and output the derived amount of charge to the switching determination unit 52G as a derivation result. The SOC derivation unit 52E is an example of the “second derivation unit.”

The output control unit 52F derives a first traveling distance which the electric vehicle 10 can travel on the basis of the derived remaining amount of a fuel. For example, the output control unit 52F derives the first traveling distance on the basis of the fuel consumption of the electric vehicle 10. At this time, the output control unit 52F may derive the first traveling distance by, for example, multiplying the fuel consumption by a weight corresponding to a terrain in which the vehicle is traveling on the basis of a position of the electric vehicle 10 in the present.

The output control unit 52F may calculate, as the first traveling distance, a value obtained by subtracting a predetermined distance based on a maximum error of the fuel sensor 126A from an actual traveling distance based on the derived remaining amount of a fuel. The maximum error of the fuel sensor 126A is, for example, 20 miles, which is determined in advance. Thus, even when a product with low detection accuracy is used as the fuel sensor 126A, it is possible to improve the reliability of the first traveling distance. On the other hand, even if the vehicle cannot travel at the first traveling distance, actually there is the remaining fuel and the vehicle can travel in some cases.

The output control unit 52F causes the output unit 60 to output information concerning the first traveling distance. For example, the output control unit 52F generates image data used for displaying the first traveling distance and outputs the image data to the display unit 62. The output control unit 52F generates sound data used for speaking the first traveling distance and outputs the sound data to the sound output unit 64.

The switching determination unit 52G determines whether the process has reached a switching timing. The switching determination unit 52G determines that the process has reached the switching timing, for example, when the derived remaining amount of a fuel is smaller than a first threshold value. The switching determination unit 52G is not limited to this and may determine that the process has reached the switching timing when a traveling distance calculated on the basis of the remaining amount of a fuel is smaller than a second threshold value. The switching determination unit 52G may determine that the process has reached the switching timing when the derived remaining amount of a fuel is smaller than the first threshold value and the traveling distance is smaller than the second threshold value.

The switching determination unit 52G rewrites a switching flag 54A of the storage unit 54 to have an on state when it is determined that the process has reached the switching timing. When the switching flag 54A has an off state, a state in which the first traveling distance is output to the output unit 60 is provided. In addition, when the switching flag 54A has an on state, a state in which a second traveling distance is output to the output unit 60 is provided. When the hydrogen tank 126 is replenished with hydrogen which is a fuel, the switching determination unit 52G may switch the switching flag to have an off state. The first traveling distance is a distance which the vehicle can travel of the electric vehicle 10 according to the remaining amount of a fuel of the power generation device. The second traveling distance is a distance which the vehicle can travel of the electric vehicle 10 according to an amount of charge, a charge rate, or the like of the battery 42.

The output control unit 52F calculates a second traveling distance which the electric vehicle 10 can travel on the basis of the derived SOC (or amount of charge) when the process has reached the switching timing and causes the output unit 60 to output information concerning the second traveling distance instead of the first traveling distance. Thus, even if the vehicle cannot travel in view of the first traveling distance, it is possible to notify an occupant that the vehicle can travel in view of the second traveling distance. As an example of such as case, for example, even if the remaining amount of a fuel derived on the basis of the fuel sensor 126A is “empty” and the electric vehicle 10 is regarded to be unable to travel, actually a case in which the vehicle can travel using the electric power of the battery 42 is included. Even if the remaining amount of a fuel derived on the basis of the fuel sensor 126A is “empty,” a case in which a fuel actually remains and it is possible to continue to generate electric power is also included. The output control unit 52F may derive the second traveling distance on the basis of a voltage value of the battery 42 detected by the battery sensor 44.

The output control unit 52F may cause the output unit 60 to output the first traveling distance when the switching flag 54A has an off state with reference to the switching flag 54A and the output unit 60 to output the second traveling distance when the switching flag 54A has an on state. Thus, it is not necessary to determine whether the process has reached the switching timing each time a traveling distance displayed in a meter is changed.

The output control unit 52F notifies an occupant that the information output from the output unit 60 is switched from the information concerning the first traveling distance to the information concerning the second traveling distance when the process has reached the switching timing. Thus, an occupant can be made aware that, since the remaining amount of the hydrogen tank 126 is exhausted, the vehicle travels only with the electric power charged in the battery system 40.

The electric power control unit 52C causes the power generation device to continue to generate electric power when the process has reached the switching timing. For example, the electric power control unit 52C instructs the FC control device 146 to continue the power generation of the power generation device until a predetermined time elapses (or the vehicle travels at a predetermined distance) from a time at which the process has reached the switching timing.

The electric power control unit 52C is not limited to this and may continue to generate electric power using the power generation device from a time at which the process has reached the switching timing to a time at which a fuel which can be supplied to the power generation device has run out. For example, the electric power control unit 52C determines that the fuel which can be supplied to the power generation device has run out when the electric power generated by the power generation device is no longer output to the battery system 40 or the DC link DL or when the generated electric power no longer arrives at the battery system 40. Even when the derived remaining amount of a fuel is smaller than the first threshold value (for example, the first threshold value=0), the fuel may actually remain in some cases. In such a case, the electric power control unit 52C instructs the FC control device 146 to continue to generate electric power until the fuel has been actually used up.

For example, the electric power control unit 52C instructs the FC control device 146 to generate electric power with the generated electric power having the maximum efficiency before the process has reached the switching timing. Furthermore, even when the process has reached the switching timing, the electric power control unit 52C instructs the FC control device 146 to continue to generate electric power with the generated electric power having the maximum efficiency. Thus, even if a very small amount of a fuel remains in the hydrogen tank 126, the fuel can be used up to the end without decreasing the power generation efficiency and it is possible to charge the battery 42 using the surplus electric power. Thus, it is possible to increase a traveling distance of the electric vehicle 10.

### <Output Control of FC System>

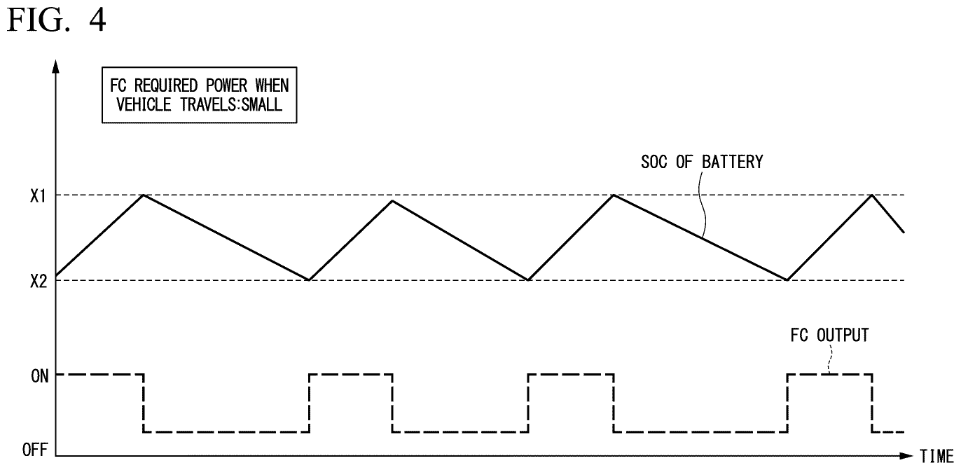

FIG. 4 is a graph for describing an example of an SOC of the battery 42 and electric power (“FC output”) output from the FC system 100 when a relatively small amount of FC required power is required for the FC system 100 when the vehicle travels. In the example illustrated in FIG. 4, when an initial value of the SOC of the battery 42 is less than a threshold value X1, the FC system 100 outputs electric power from the FC system 100 to the battery 42 to increase the SOC of the battery 42. In this case, the FC system 100, for example, performs power generation with an amount of power generation in which the power generation efficiency is maximized and outputs the generated electric power to the battery 42.

Subsequently, the FC system 100 limits electric power output from the FC system 100 to the battery 42 when the SOC of the battery 42 has reached the threshold value X1 and reduces the SOC of the battery 42. Subsequently, the FC system 100 returns the electric power output from the FC system 100 to the battery 42 to the state before the limit and increases the SOC of the battery 42 when the SOC of the battery 42 has reached a threshold value X2. As a result, the control in which the SOC of the battery 42 increases from the threshold value X2 to the threshold value X1 and the control in which the SOC of the battery 42 decreases from the threshold value X1 to the threshold value X2 are repeatedly performed.

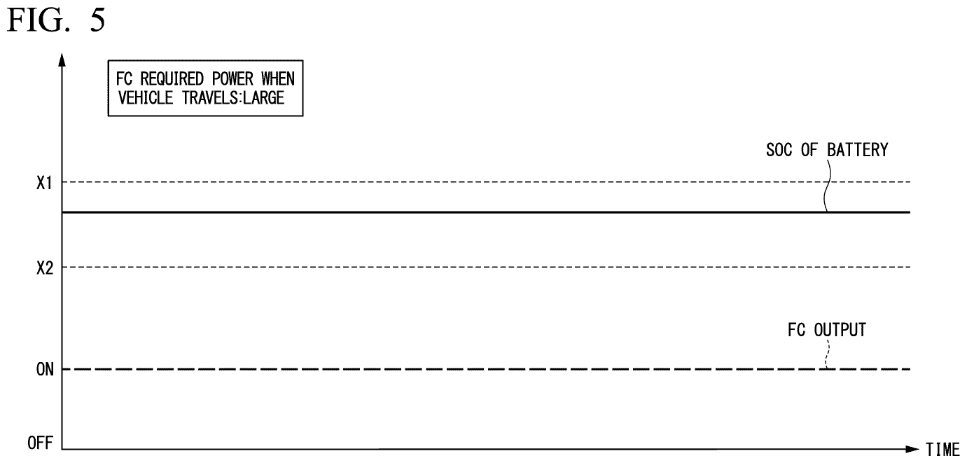

FIG. 5 is a graph for describing an example of the SOC of the battery 42 and electric power output from the FC system 100 when a relatively large amount of FC required power is required for the FC system 100 when the vehicle travels. In the example illustrated in FIG. 5, the FC system 100 outputs a driving force used for traveling of the electric vehicle 10 from the motor 12 to the drive wheel 14 using electric power generated in the FC system 100 without using electric power stored in the battery 42. As a result, the SOC of the battery 42 is maintained, electric power is generated in the FC system 100 in accordance with the FC required power required for the FC system 100, and the generated electric power is output to the motor 12.

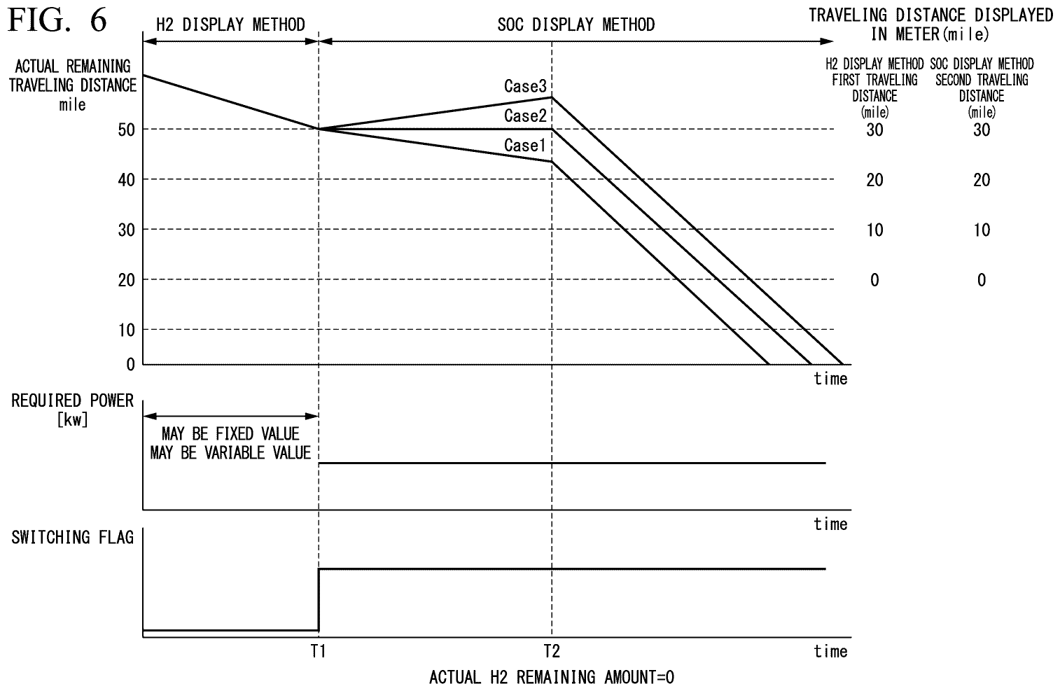

FIG. 6 is a diagram illustrating an example of a change in traveling distance over time. A horizontal axis represents a time and a vertical axis represents a distance which the vehicle can travel and the like. An “actual remaining traveling distance” indicating a distance which the vehicle can travel with the remaining amount of a fuel of the fuel sensor 126A is described on a left vertical axis. A “first traveling distance” obtained by subtracting an amount corresponding to an error of the fuel sensor 126A from the “actual remaining traveling distance” and a “second traveling distance” based on the SOC of the battery 42 are described on a right vertical axis. Here, it is assumed that the remaining traveling distance at an SOC control median is 30 miles and a maximum error of the fuel sensor 126A is 20 miles.

Time T1 is a time at which the process has reached a switching timing and Time T2 is a time at which hydrogen of the hydrogen tank 126 has been finished. Required power may be a fixed value or a variable value and can be set arbitrarily until Time T1. On the other hand, the required power is fixed to an amount of electric power in which electric power can be generated with the maximum efficiency after Time T1. A switching flag has an off state until Time T1 and has an on state after Time T1.

During a period to Time T1, it is assumed that a state in which the electric vehicle 10 travels at a constant speed on a terrain having a height difference is provided. During the period to Time T1, a traveling distance output to the output unit 60 is a first traveling distance derived on the basis of the remaining amount of the hydrogen tank 126. During the period to Time T1, the first traveling distance decreases with the passage of time.

During a period from Time T1, a traveling distance output to the output unit 60 is a second traveling distance derived on the basis of the SOC of the battery 42. During a period from Time T1 to Time T2, the second traveling distance differs in accordance with a load.

Case 1 is a case in which a load is larger than an amount of power generation, Case 2 is a case in which a load is the same as an amount of power generation, and Case 3 is a case in which a load is smaller than an amount of power generation. In Case 1, the electric vehicle 10 travels using not only the generated electric power but also the electric power of the battery 42. For this reason, the second traveling distance decreases with the passage of time. In Case 2, the electric vehicle 10 travels only using the generated electric power. For this reason, the electric power of the battery 42 does not decrease and the second traveling distance is constant. In Case 3, the generated electric power is output to the electric vehicle 10 and the surplus electric power is stored in the battery 42. For this reason, the electric power of the battery 42 increases and the second traveling distance increases with the passage of time.

During the period from Time T2, power generation is stopped. Thus, the electric power of the battery 42 gradually decreases and the second traveling distance decreases with the passage of time.

### [Processing Flow of Vehicle System]

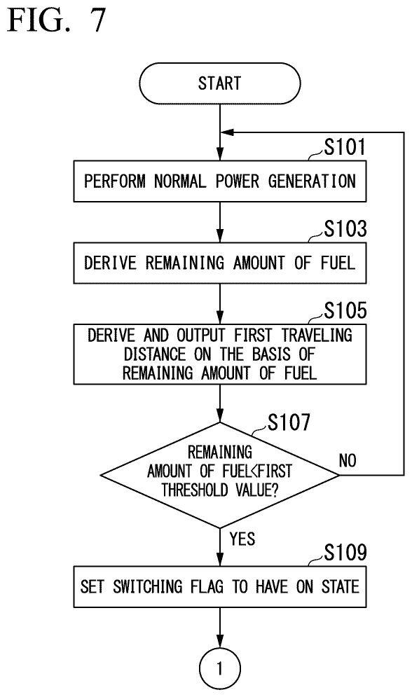

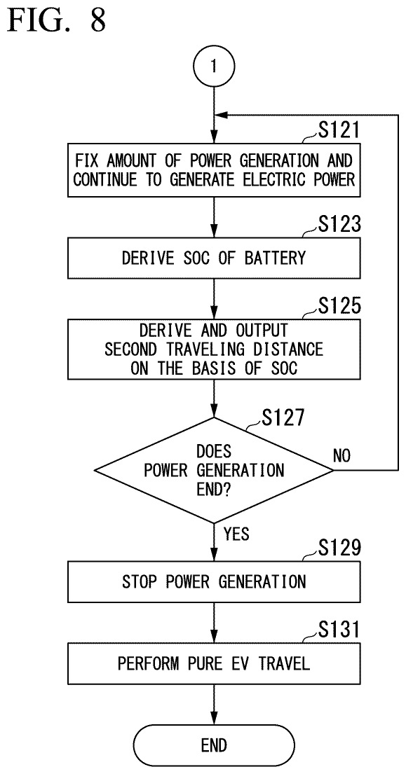

A flow of a series of processes in the power control device 50 which is a control computer of a vehicle system 1 according to a first embodiment will be described below. FIGS. 7 and 8 are flowcharts for describing an example of a flow of processing performed using the power control device 50. The flowchart illustrated in FIG. 7 is performed, for example, when the electric vehicle 10 starts traveling.

First, the power control device 50 performs normal power generation (Step S101). For example, the electric power control unit 52C instructs the FC control device 146 to generate electric power with the generated electric power having the maximum efficiency. Subsequently, the fuel derivation unit 52D derives the remaining amount of a fuel supplied to the power generation device on the basis of the detection result of the fuel sensor 126A (Step S103).

The output control unit 52F derives a first traveling distance which the electric vehicle 10 can travel on the basis of the remaining amount of a fuel derived in Step S103 and causes the output unit 60 to output the derived first traveling distance (Step S105). Furthermore, the switching determination unit 52G determines, for example, whether the derived remaining amount of a fuel is smaller than a first threshold value (Step S107). Here, the first threshold value is, for example, an amount of fuel corresponding to a traveling distance of 30 miles. The process of Step S107 is to determine whether the process has reached a switching timing and may be a process in which a determination regarding whether the first traveling distance is smaller than a second threshold value is performed. Here, the second threshold value is, for example, 30 miles.

When the derived remaining amount of a fuel is greater than or equal to the first threshold value, the power control device 50 returns to the process of Step S101 and the process is repeatedly performed. On the other hand, in Step S107, when the derived remaining amount of a fuel is smaller than the first threshold value, the switching determination unit 52G sets the switching flag to have an on state (Step S109). Furthermore, the process transitions to the process associated with FIG. 8.

As shown in FIG. 8, the electric power control unit 52C instructs the FC control device 146 to fix an amount of power generation (for example, an amount of power generation having the maximum efficiency) and continue to generate electric power (Step S121). The SOC derivation unit 52E derives the SOC of the battery 42 on the basis of the output of the battery sensor 44 (Step S123). A second traveling distance which the electric vehicle 10 can travel is calculated on the basis of the derived SOC and the output unit 60 is caused to output information associated with the second traveling distance instead of the first traveling distance (Step S125).

Subsequently, the electric power control unit 52C determines whether to end power generation (Step S127). When it is determined that the power generation is not ended, the electric power control unit 52C returns to the process of Step S121 and the process is repeatedly performed. On the other hand, the electric power control unit 52C determines that the power generation ends when a predetermined time has elapsed (or the vehicle travels at a predetermined distance) from a time at which the process has reached the switching timing or a fuel which can be supplied to the power generation device has run out. Furthermore, the electric power control unit 52C instructs the FC control device 146 to end the power generation (Step S129). After that, the electric vehicle 10 transitions to pure EV traveling in which the electric vehicle 10 travels using only the electric power of the battery 42 (Step S131).

As described above, according to the vehicle system according to the embodiment, the vehicle system installed in the vehicle, includes: the power generation device; the electric power control unit which controls power generation of the power generation device; the first derivation unit which derives the remaining amount of a fuel supplied to the power generation device on the basis of the detection result of the first sensor attached to any one of the power generation device, the fuel storage unit, and the fuel supply path; the power storage device which stores the electric power generated by the power generation device; the second derivation unit which derives the amount of charge or the charge rate of the power storage device on the basis of the detection result of the second sensor attached to the power storage device; and the output control unit which calculates the first traveling distance which the vehicle can travel on the basis of the derived remaining amount of a fuel and causes the output unit to output the information associated with the first traveling distance, wherein, when the derived remaining amount of a fuel is smaller than the first threshold value or the first traveling distance calculated on the basis of the remaining amount of a fuel is smaller than the second threshold value, the electric power control unit is able to cause the power generation device to continue to generate electric power and the output control unit is able to notify the occupant of the distance which the vehicle can travel in consideration of the remaining amount of charge of the remaining amount of a fuel of the power generation device or the remaining amount of charge of the power storage device by calculating the second traveling distance which the vehicle can travel on the basis of the derived amount of charge or charge rate and causing the output unit to output the information associated with the second traveling distance.

The above-described switching timing is not limited to a case in which a very small amount of a fuel remains. For example, the first threshold value or the second threshold value may be a value larger than 0. The switching timing may be when the remaining amount of a fuel is smaller than the first threshold value (or the first traveling distance is smaller than the second threshold value) and when the SOC is smaller than a third threshold value (or the second traveling distance is smaller than a fourth threshold value). Thus, for example, when the third threshold value is set to an SOC median (for example, 50%) of the battery 42, it is possible to prevent a traveling distance to be output from jumping at the time of switching from the first traveling distance to the second traveling distance.

Although the embodiments for carrying out the present invention have been described using the embodiments as described above, the present invention is not limited to the embodiments at all and various modifications and substitutions are possible without departing from the gist of the present invention. For example, although an example in which an example of the power generation device is the fuel cell such as the FC system 100 has been described, the power generation device is not limited to this example. For example, the electric vehicle 10 also includes a vehicle (for example, a plug-in hybrid car) which can travel with the electric power generated using a gasoline engine when the charging power is insufficient, in addition to the charging power for a traveling battery. In this case, the power generation device includes a gasoline engine.

What is claimed is:

1. A display system installed in a vehicle, comprising:
a processor configured to
derive the remaining amount of a fuel supplied to a power generation device on the basis of the detection result of a first sensor attached to any one of a power generation device, a fuel storage unit, and a fuel supply path,
derive an amount of charge or a charge rate of a power storage device on the basis of the detection result of a second sensor attached to the power storage device that stores electric power generated by the power generation device,
display information associated with a first traveling distance that the vehicle is able to travel on the basis of the derived remaining amount of a fuel on a display,
when the derived remaining amount of a fuel is smaller than a first threshold value or when the first traveling distance calculated on the basis of the remaining amount of a fuel is smaller than a second threshold value,
display information associated with a second traveling distance that the vehicle is able to travel on the basis of the derived amount of charge or charge rate of a power storage device in a state with the power generation device generates electric power having maximum efficiency on display.

2. The vehicle system according to claim 1,
wherein the processor switches the information associated with the second traveling distance from the information associated with the first traveling distance and display the information associated with the second traveling distance on the display.

3. The vehicle system according to claim 1,
wherein the processor displays the first traveling distance on the display, the first traveling distance is a value obtained by subtracting a predetermined distance based on an error of the first sensor from an actual traveling distance based on the derived remaining amount of a fuel.

4. A display control method performed by an in-vehicle computer, the vehicle control method comprising:
deriving the remaining amount of a fuel supplied to a power generation device on the basis of the detection result of a first sensor attached to any one of a power generation device, a fuel storage unit, and a fuel supply path,
deriving an amount of charge or a charge rate of a power storage device on the basis of the detection result of a second sensor attached to the power storage device that stores electric power generated by the power generation device,
displaying information associated with a first traveling distance that the vehicle is able to travel on the basis of the derived remaining amount of a fuel on a display,
when the derived remaining amount of a fuel is smaller than a first threshold value or when the first traveling distance calculated on the basis of the remaining amount of a fuel is smaller than a second threshold value,
displaying information associated with a second traveling distance that the vehicle is able to travel on the basis of the derived amount of charge or charge rate of a power generation device generates electric power storage device in a state with the power having maximum efficiency on display.

5. A computer-readable non-transitory storage medium storing a program causing an in-vehicle computer to execute:
deriving the remaining amount of a fuel supplied to a power generation device on the basis of the detection result of a first sensor attached to any one of a power generation device, a fuel storage unit, and a fuel supply path,
deriving an amount of charge or a charge rate of a power storage device on the basis of the detection result of a second sensor attached to the power storage device that stores electric power generated by the power generation device,
displaying information associated with a first traveling distance that the vehicle is able to travel on the basis of the derived remaining amount of a fuel on a display,
when the derived remaining amount of a fuel is smaller than a first threshold value or when the first traveling distance calculated on the basis of the remaining amount of a fuel is smaller than a second threshold value,
displaying information associated with a second traveling distance that the vehicle is able to travel on the basis of the derived amount of charge or charge rate of a power storage device in a state with the power generation device generates electric power having maximum efficiency on display.
